(19) United States
(12) Patent Application Publication
(10) Pub. No.: US 2008/0180842 A1
(43) Pub. Date: Jul. 31, 2008

(54) OBJECT STORAGE DEVICE HAVING SHAKING FUNCTION

(75) Inventors: Klaus KAUFMANN, Muenchen (DE); Stefan Betz, Erlensee (DE); Helmut Loscher, Nidderau (DE); Hubert Heeg, Moembris (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THERMO ELECTRON LED GMBH, Langenselbold (DE)

(21) Appl. No.: 12/019,388

(22) Filed: Jan. 24, 2008

(30) Foreign Application Priority Data
Jan. 26, 2007 (DE) DE 102007004072.7

(51) Int. Cl. G11B 23/02

(52) U.S. Cl. 360/132

(57) ABSTRACT

The present invention relates to an object storage device having shaking function having a vertically situated storage cassette, which has multiple object storage points situated one on top of another, and having a drive unit functionally connected to the storage cassette via a first drive connection, comprising at least one drive element for performing a shaking movement of the storage cassette. The present invention also relates to a climatic cabinet having such an object storage device.

### CROSS-REFERENCE TO RELATED APPLICATIONS

This application claims priority of German Patent Application DE 102007004072.7 filed Jan. 26, 2007, the contents of which is incorporated by reference in its entirety.

### BACKGROUND OF THE INVENTION

The present invention relates to an object storage device having a shaking function having a vertically situated storage cassette, which has multiple object storage points situated one on top of another, and having a drive unit functionally connected to the storage cassette via a first drive connection, comprising a drive element for performing a shaking movement of the storage cassette. The present invention also relates to a climatic cabinet having an above-mentioned object storage device.

An object storage device is understood in this context as a device in which objects may be received at multiple object storage points situated one on top of another in a tower. Multiple in the meaning of the present invention particularly means more than five and very particularly more than ten. Objects are very particularly closed containers, mic rotitration plates, and similar containers for receiving samples. An object storage device of this type is known, for example, from EP 1 155 743 A2. It has multiple inserts situated one on top of another in a stack for receiving sample carriers, such as microtitration plates in particular. The integration of a shaking function proves difficult here, however, because in this object storage device the objects introduced into the inserts are stored loosely in the object storage points and thus may fall out of the retainers due to a shaking movement of the storage cassette. Furthermore, object storage devices having fasteners for objects are known, such as the tab-like positioning elements, which project above the floor area of an object storage point, of EP 0 725 133 A2. However, these do not allow shake-proof locking of the object, but rather are exclusively used to ensure an object is inserted completely into an object storage point. The use of retention angles is known in the field of shaking units from EP 1 201 297 A1, for example. The object is placed from above in the retention angle and held loosely by the retention angle in the shaking unit, which shakes in the horizontal plane. The use of retention angles is precluded for an object storage device having multiple object storage points situated one on top of another, however, because introducing the objects from above is disadvantageous due to of the increased space demand, for example. First improvement approaches in this context arise from DE 103 02 809 A1, which discloses the use of one-piece or multipart clamping elements in the form of fixing angles. However, this attempted solution also requires the introduction of the objects into the object storage point from above, so that this device is only poorly suitable for storing and shaking larger numbers of objects and/or larger storage cassettes having multiple object storage points lying one on top of another. In addition, ensuring uniform distribution of the shaking movement over the entire length of the storage cassette is problematic in the development of object storage devices having multiple and in particular more than 10 object storage points per cassette. An uneven extent of the shaking movement in the individual object storage points is particularly problematic because the shaking results obtained are not uniform over the longitudinal axis of the storage cassette and are thus not reproducible.

The above-mentioned disadvantages arise particularly clearly in climatic cabinets having such object storage devices, in which multiple objects are stacked one on top of another.

### SUMMARY OF THE INVENTION

The object of the present invention is thus to improve the handling and operation of an object storage device having multiple object storage points situated one on top of another, in particular in regard to uniform and reproducible shaking of all objects situated in the storage cassette.

The object is achieved for an object storage device having a shaking function having a vertically situated storage cassette, which has multiple object storage points situated one on top of another, and having a drive unit functionally connected to the storage cassette via a first drive connection, comprising a drive element for performing a shaking movement of the storage cassette, in that it has a further functional connection of the drive unit to the storage cassette via a second drive connection, the first drive connection being connected to a floor area of the storage cassette and the second drive connection being connected to a head area of the storage cassette, and a control unit is provided, which is implemented to synchronize the two drive connections. An essential basic idea of the present invention is thus to integrate multiple drive connections for the functional connection of the drive unit to the storage cassette in the object storage device. A functional connection in the meaning of the present invention is particularly to be understood as a connection for transmitting drive power generated by the drive element, such as a motor, for shaking to the storage cassette. This may occur via a direct connection, for example, via a gear, or, for example, also via magnetic interactions which are triggered via the drive unit and are transmitted to the storage cassette in the area of the drive connection. Accordingly, a drive unit comprises at least one drive element and possibly, for example, gear elements, etc., which are used to transmit the drive power exerted by the drive element to trigger the shaking movement of the storage cassette. According to the present invention, the first and second drive connections are connected to the storage cassette spatially separate from one another. For this purpose, it is advantageous to space apart the engagement points of the first and second drive connections as far as possible from one another. In this way, it is possible to transmit the shaking movement of the storage cassette not only on one side, but rather on multiple sides, and in particular on two sides to the storage cassette. An especially uniform shaking movement which is homogeneous over the entire storage cassette is thus executed. A further essential basic idea of the present invention is the synchronization of the first and second drive connections. This synchronization of the movements of the first and second drive connections ensures that the storage cassette is shaken uniformly over its entire longitudinal axis and allows a torsion-free shaking movement of the storage cassette. It is therefore possible to achieve especially good, reproducible shaking results using an object storage device according to the present invention, so that also storage cassettes having more than 10 and particularly more than 15 object storage points situated one on top of another may be shaken reliably and uniformly over the entire storage area and in particular over the entire longitudinal extension of the storage cassette.

The first and second drive connections preferably lie opposite to one another in relation to the storage cassette, the first drive connection being functionally connected from below and the second drive connection being functionally connected from above and especially preferably at diametrically opposite border areas to the at least one storage cassette. A connection of the first drive connection in the vertical direction of the storage cassette to the upper head area of the storage cassette and of the second connection to the lower floor area of the storage cassette is thus especially preferred. A connection of this type of the first and second drive connections to the front faces along the longitudinal axis of the storage cassette is particularly advantageous, because in this way an especially uniform shaking movement which is homogeneous over the entire length of the storage cassette may be ensured particularly well.

In an especially preferred embodiment, the drive element is an electromagnetic drive. Electromagnetic drives are distinguished by their particularly high functional reliability and their comparatively simple construction.

The drive unit is implemented in an especially preferred embodiment for performing various shaking movements and in particular for performing orbital, linear, and diagonal shaking movements. A drive unit of this type is advantageous because the user may select between various shaking movements. Multiple shaking movements may preferably be combined with one another, so that in this way particularly outstanding shaking results may be obtained.

It is preferable if the drive element may execute these various shaking movements directly, because the use of complex gear elements may thus be dispensed with. Typical shaking movements of the present invention relate to movements of the storage cassette in the XZ plane and/or in the horizontal plane. These are circular, ellipsoidal, arcing, or zigzag shaking movements, or shaking movements changing in a linear path, for example. In relation to a rectangular floor surface of an object storage point, the movement patterns may thus occur linearly or also diagonally, for example. In addition, various shaking movements may be combined with one another especially using a direct drive. Such shaking movements may be obtained especially well using a drive element having the basic action principle described in EP 1 201 297 A1, for example, in which a shaking plate is directly driven by the action of magnets and coils. Nearly arbitrary movement patterns may be executed in the horizontal plane by this interplay of magnets and coils. In addition, the magnetic direct drive of EP 1 201 297 A1 allows a reduction of the moved masses. Especially this action principle of a magnetic drive is thus particularly advantageous.

The drive unit preferably has a first and a second drive element, the first drive element being connected to the storage cassette via the first drive connection and the second drive element being connected via the second drive connection, and the control unit being implemented to synchronize the shaking movement performed by the first and second drive elements. The use of multiple drive elements allows the use of lower-power drive elements, such as lower-power electric motors. This is particularly advantageous for the use of an object storage device according to the present invention in a climatic cabinet, and particularly in an incubator, because low-power drives cause only a minimal introduction of heat. In this way, the temperature control of the climatic cabinet or the incubator is made significantly easier and/or the temperature error triggered by the drive unit is especially low, in particular insofar as essential components of the drive unit are integrated directly in the temperature-controlled inner chamber of the climatic cabinet or the incubator. In addition, for example, comparatively high speed ranges of up to 1500 rpm at an amplitude of 1 mm may be achieved with a drive unit of this type.

An at least partially moisture-tight implementation of the drive unit, and in particular of the first and second drive elements of the drive unit, has particularly proven itself. This is true especially for those parts of the drive unit which are situated directly in the temperature-controlled area, such as the inner chamber of a climatic cabinet and in particular the inner chamber of an incubator, of the object storage device according to the present invention. This special embodiment on one hand allows the object storage device not only to be operated under dry climatic conditions, but rather also under conditions having high ambient humidity. Due to the moisture-tight embodiment of those elements of the drive unit and in particular the first and second drive elements, damage to these elements by condensing water is prevented. On the other hand, the access to these components via the inner chamber of the object storage device provides the advantage to the user that these components are reachable directly via the inner chamber, for example, for maintenance purposes, and housing components, etc., do not have to be removed first.

Furthermore, it is advantageous if the first and second drive elements are implemented having identical constructions. This embodiment is preferable insofar as the synchronization of the executed shaking movements is made significantly easier. In addition, the number of different parts required for assembling such an object storage device in the production process may be reduced. Such an object storage device is thus also particularly cost-effective to produce and maintain.

The object storage device preferably has more than one storage cassette, particularly two storage cassettes, which may preferably be shaken independently of one another. An object storage device which has at least two storage cassettes, each of the storage cassettes having a first and a second drive connection, is especially preferred. In this way, the usage flexibility and simultaneously the storage capacity of the object storage device according to the present invention may be increased. The at least two storage cassettes are situated adjacent to one another or also one on top of another in the horizontal plane, for example.

Furthermore, it is usable in particularly manifold ways and thus advantageous if the control unit is implemented for separate control of the two storage cassettes from one another. The shaking movements of the individual storage cassettes may thus be controlled individually via the control unit in this embodiment. This allows the stopping of the shaking movement of one storage cassette, the second storage cassette being shaken further. As a result, this embodiment is particularly user-friendly, because it is possible to change objects in one storage cassette without interrupting the shaking movement of the other storage cassette(s), and simultaneously uniform and reproducible shaking results may be obtained by the shortened interruption intervals.

To ensure an effective transmission of the shaking movement of the storage cassette to the objects stored in the storage cassette, in an especially preferred embodiment of the present invention, a fixing unit having a fixing element for fixing the object, in particular a plate-shaped sample carrier such as a microtitration plate, in one of the object storage points and having an actuating device is provided, the actuating device being implemented to adjust the fixing element between a “fix” position and a “release” position, and the object being fixed in one of the object storage points in the “fix” position and being removable from this object storage point in the “release” position. A fixing element in the meaning of the present invention is thus at least one component which may fix an object in an object storage point, so that the object does not slip back and forth in the object storage point, in particular in the course of a shaking movement exerted on the storage cassette. This fixing particularly relates to the fixing of the object in the object storage point in regard to horizontal movements of the storage cassette, as were already described above. The actuating device according to the present invention allows an object fixed in the object storage point by the fixing element to be removed insofar as the object may be taken out of the object storage point after the disengagement of the fixing. This is performed, for example, by pulling the object out of the insert-like object storage point. An essential basic idea of the present invention is thus the active monitoring of the positioning of the fixing element by the actuating device. This is particularly advantageous because disengagement of the fixing element is not controlled by the object itself, as is the case with the retention angles from the prior art, for example. By the active changeover of the fixing element from the “fix” position into the “release” position by the actuating device, rather, a changeover of the fixing element executed independently of the object and/or disengagement and fixing of the fixing mechanism without a movement of the object in the object storage point is possible. The present invention thus unifies multiple advantages at the same time. On one hand, the object is fixed stationary and stably and particularly in the preferably horizontal movement plane in relation to the storage cassette in the object storage point especially during shaking of the storage cassette. On the other hand, it is possible to introduce and remove an object to and from the object storage point easily and particularly without jerking, because the fixing mechanism may be controlled actively and independently of the object.

Fixing elements in multiple object storage points and in particular in all object storage points of a storage cassette may preferably be adjusted from the “fix” position into the “release” position combined via the actuating device. Multiple and preferably all fixing elements of a storage cassette may thus be switched simultaneously and jointly from the “fix” position into the “release” position by the one actuating device. The user has the capability in this way of disengaging all objects fixed by fixing elements in a storage cassette from the fixing in one work step. This embodiment is particularly efficient because individual and time-consuming disengagement of each individual fixing element of a storage cassette is dispensed with.

In an especially advantageous embodiment, the actuating device has an actuating strip situated vertically in the object storage device for the combined switching of all fixing elements of the at least one storage cassette between the “fix” position and the “release” position. The control of the changeover of all fixing elements to release the objects fixed in the individual object storage points thus occurs in this embodiment according to the present invention via a position change of the actuating strip, which is preferably mounted so it is pivotable. Control via an actuating strip has proven to be particularly reliable.

The fixing element of the fixing unit preferably has a two-arm lever having a control lever, which is in contact with the actuating device and in particular with an actuating strip to switch the fixing element between the “fix” position and the “release” position, and a fixing lever, which has at least one partial area pressing laterally against the object to fix the object in the object storage point. The fixing unit thus has a lever function, via which the function of the fixing mechanism of the fixing element is controlled. The control lever acts as a control contact, in particular in operational connection to an actuating strip, so that the positioning of the two-arm lever is controlled by the actuating device via the control lever. In the scope of the present invention, the actuating strip is particularly a component which is implemented as strip-like and very particularly allows the simultaneous activation of multiple control levers of multiple object storage points. For this purpose, the actuating strip runs essentially vertically along the storage cassette, for example. The fixing lever is used for the direct fixing of the object in the object storage point. For this purpose, the fixing lever typically presses laterally against the object, such as a microtitration plate, in the “fix” position, and presses it laterally against a wall area of the object storage point opposite to the contact side between object and fixing lever. Furthermore, coatings and/or pressure elements may be present between the fixing lever and the object, which finally transmit the lateral fixing action of the fixing lever to the object in the “fix” position. Coatings and/or pressure elements of this type may additionally improve the position stability of the fixed object. The fixing lever may thus act indirectly or also directly on the object to be fixed.

The implementation of the two-arm lever as a leaf spring has particularly proven itself. Leaf springs have a simple construction and a high functional reliability and are additionally comparatively cost-effective to produce. Leaf springs are thus advantageous.

An implementation of the fixing lever in the “fix” position in such a way that it encloses an object introduced into the object storage point in the area of the object front edge to prevent the object from slipping out of the object storage point is thus particularly effective and thus advantageous. In addition to the lateral fixing action of the fixing lever transversely and particularly perpendicularly to the insertion direction of the object into the object storage point, in this preferred embodiment, an additional slip safety is thus provided, which prevents the object from slipping out, in particular opposite to the insertion direction of the object. For this purpose, the fixing lever preferably encloses at least a part of the object front edge. The object front edge relates in this context to the edge of the object and in particular of the microtitration plate on the insertion side of the storage cassette. This slip safety is preferably designed in such way that a force acting in the insertion direction of the object into the object storage point is exerted on the object by the at least partial enclosing of the object front edge by the fixing lever. This embodiment is particularly reliable in regard to the stability of the storage of the object in the object storage point, because the object is not only laterally clamped, but rather additionally secured from undesired slipping out of the object storage point. The slip safety and the fixing lever are preferably implemented in one piece, so that the fixing lever exerts both a lateral force and also a force acting in the insertion direction of the object on the object in the “fix” position.

The fixing lever is preferably spring-loaded in such a way that the spring loading acts in the “fix” position of the fixing lever. Spring loading of this type thus has the result that due to triggering of the actuating device, the fixing lever is moved by the spring loading, which is achieved by a compression spring, for example, back into the “fix” position independently of the actuating device. An active changeover, for example, by the actuating strip, of the fixing lever from the “release” position into the “fix” position by the actuating device is thus not required. This embodiment is advantageous because the actuating device does not have to be implemented to reset the fixing lever and thus may have a simplified construction.

A motor-driven fixing unit has particularly proven itself for achieving the object. The motor-driven fixing unit is advantageous because it is particularly user-friendly. The manual changeover of the actuating device, which requires significant force depending on the size of the object storage device, is dispensed with here. It has been proven to be particularly advantageous to equip the actuating device especially and the actuating strip of the actuating device of the fixing unit in particular as motor-driven. In particular in combination with the above-mentioned spring loading, an especially user-friendly object storage device results in this way, because both the fixing triggered by the spring loading and also the release of the objects triggered by the motor-driven actuating device run automatically and do not require any manual intervention.

Furthermore, it is advantageous if the fixing unit has a self-locking gear. By using a self-locking gear it is possible to maintain the positioning of the fixing unit and in particular of the actuating device in a simple way without continuous powering of a drive being necessary, for example.

The combination of an object storage device according to the present invention with the fixing unit described above thus represents an especially elegant achievement of the object. Specifically, the advantages of the above-mentioned fixing unit may be unified with the advantages of the drive device according to the present invention in this embodiment. Such an object storage device allows reproducible and uniform shaking movements over the entire longitudinal axis of the vertically situated storage cassette to be ensured simultaneously very particularly well.

The use of one of the object storage devices according to the present invention described above in a climatic cabinet and in particular in an incubator has especially proven itself. It is possible, for example, to use low-power motors with the above-mentioned advantages due to the special drive device. The above-mentioned object storage devices according to the present invention having a fixing unit are also especially well suitable, because of the simple operability and the high functional reliability, for a climatic cabinet and very especially for an incubator and in particular here an automated incubator, because an automatic fixing and release unit may be combined especially advantageously with automated loading and unloading of the stored objects.

In this context, another refinement of the present invention is also to be cited, which especially makes automated loading and unloading of the object easier. In this refinement, a locking device is provided, which locks the storage cassette in a defined position, when the at least one fixing element is in the “release” position and thus the stored objects may be removed or objects may be inserted. To be able to be shaken, the storage cassette must be mounted having a certain play. If the shaking procedure was simply interrupted to remove or insert objects, the position of the storage cassette would thus differ depending on the instant of the stop of the shaking procedure. Automatic charging and removal of the objects in and from the storage cassette in a precise position would thus hardly be possible. According to the present invention, a locking device is therefore provided, which brings the storage cassette into a defined loading and unloading position upon release of the fixing elements and locks it there. To avoid unintended slipping of the objects, the storage cassette is expediently first brought into the loading and unloading position before the objects are released by changing over into the “release” position. After the changeover of the fixing elements into the “fix” position, the locking of the storage cassette is disengaged again, so that a shaking procedure may be performed again. All procedures are expediently controlled by the control unit.

### BRIEF DESCRIPTION OF THE DRAWINGS

In the following, the present invention is explained in greater detail on the basis of the exemplary embodiments illustrated in the figures.

FIG. 1 shows a schematic exploded illustration to scale of an object storage device;

FIG. 2 shows a perspective illustration of an actuating device having fixing elements;

FIG. 3a shows a schematic top view of an actuating device having fixing elements in the “fix” position;

FIG. 3b shows a detail view of a horizontal section along a fixing element in the “fix” position;

FIG. 4a shows a schematic top view of an actuating device having fixing elements in the “release” position;

FIG. 4b shows a detail view of a horizontal section along a fixing element in the “release” position; and

FIG. 5 shows a detail view of a horizontal section along a leaf spring fastener between two fixing elements in the “fix” position.

### DETAILED DESCRIPTION

In the embodiments illustrated in the following, identical components are provided with identical reference numerals.

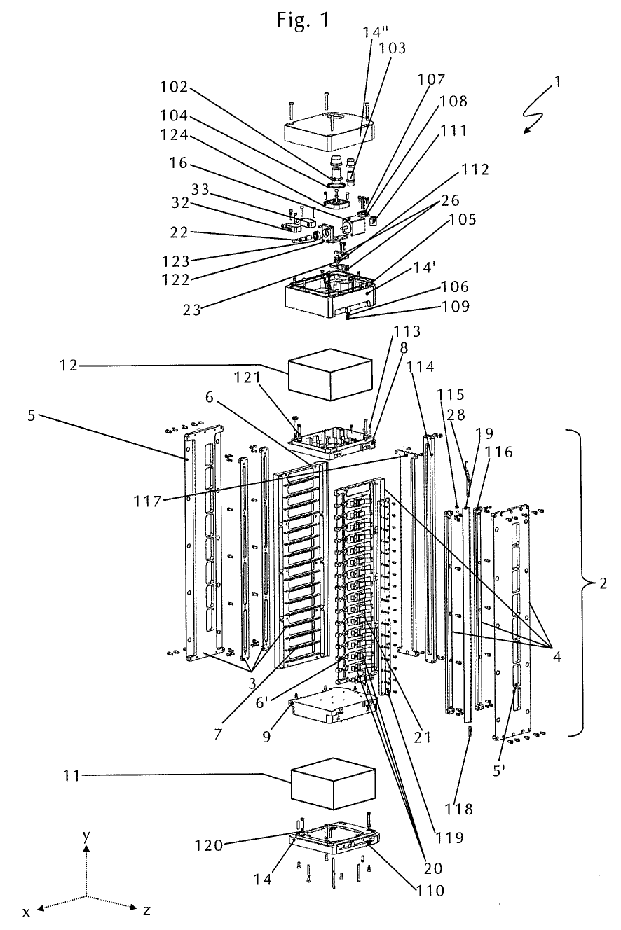

The object storage device 1 in FIG. 1 comprises a storage cassette 2 having two vertically running side walls 3 and 4, which each have, inter alia, a support 5 or 5′ and a ladder-like side wall plate 6 or 6′, respectively. Diametrically opposite rail-like guides 7 (solely indicated partially for the left side wall 3 in FIG. 1) are situated in pairs on the ladder-like side wall plates 6 and 6′ of the side walls 3 and 4, which are implemented for inserting and guiding objects (not shown) and in particular microtitration plates in the storage cassette 2. One guide pair (i.e., one rail-like side of the ladder 6 and one rail-like side of the ladder 6′ situated at the same height (not shown in FIG. 1)) thus establishes one object storage point of the object storage device 1. A spring plate 8 or 9 is situated above and below, respectively, the side walls 3 and 4, which delimit the vertically situated storage cassette 2 on the top (upper spring plate 8) and on the bottom (lower spring plate 9) at the front faces. A drive element (drive element 11 below the storage cassette 2 and drive element 12 above the storage cassette 2) adjoins the swing plate 8 or 9 on the side opposite to the storage cassette in the vertical direction (y axis in FIG. 1), which drives the shaking movements of the storage cassette 2 in the horizontal plane (XY plane in FIG. 1) synchronized by a control unit (not shown) and/or is functionally linked to one of the two swing plates 8 or 9. The drive elements 11 and 12 are schematically indicated by the two boxes in FIG. 1. The synchronization of the two drive elements 11 and 12 by the control unit allows torsion-free and uniform shaking of the vertically situated storage cassette 2 in the horizontal plane. This uniform shaking occurs over the entire longitudinal axis of the entire storage cassette 2. The drive elements 11 and 12 are electromagnetic direct drives, whose fundamental implementation is described, for example, in EP 1 201 297 A1, comprising magnets and coils, the movement being caused by interaction of the magnet and coils. The drive elements 11 and 12 are attached to a housing of a climatic cabinet on the side facing away from the storage cassette 2 in the vertical direction (only the connection points to this housing are shown in FIG. 1, the housing per se is not shown FIG. 1). Only the parts 14, 14′, and 14″ of the housing are illustrated in FIG. 1, the housing of the object storage device 1 nearly completely enclosing the storage cassette 2 according to the present invention in the embodiment shown in FIG. 1 and comprising a passage area (not shown) closable using a door, through which objects may be transported outward from the interior of the housing and vice versa, for example, using a charging robot. Using the object storage device 1 illustrated in FIG. 1 in a climatic cabinet (housing not shown), a movement of the objects stored in the storage cassette 2 is finally possible under controlled climatic conditions. For this purpose, in particular the two drive elements 11 and 12 are implemented as moisture-tight, a movement of objects (not shown) stored in the object storage device 1 also being possible under humid conditions, without condensed water being able to penetrate into the drive elements 11 and 12 situated directly in the climate-controlled internal chamber of the climatic cabinet (not shown).

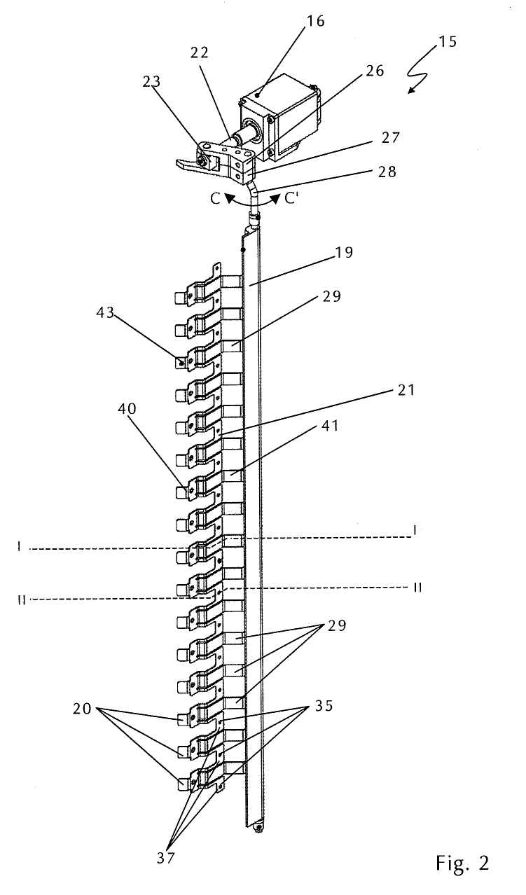

Furthermore, the object storage device 1 shown in FIG. 1 has a fixing device 15 (shown in detail in FIG. 2), particularly comprising a drive motor 16, two micro switches 32 and 33, a gear having, inter alia, a threaded spindle 22, a dog nut 23, a forked transfer element 26, and a pivot axis 28, an actuating strip 19 (eccentric strip), and multiple leaf-spring-like fixing elements 20 (only a selection of the leaf-spring-like fixing elements 20 are expressly identified in FIG. 1 for the sake of clarity). The individual leaf-spring-like fixing elements 20 are connected to one another and form a spring strip 21 in their entirety. The drive motor 16 of the fixing device 15 is situated above the storage cassette 2 and has a threaded spindle 22 according to FIG. 2 (the thread itself is not shown in the figures), by whose rotation a dog nut 23 having internal thread (not shown) is movable linearly along the threaded spindle 22 in relation to the threaded spindle 22.

Further components of the object storage device identified in greater detail in FIG. 1 are the cable bushings 102 and 103, O-rings 104 through 106, the disk 107, the plate 108, sockets 109 and 110, the pin 111, the threaded pin 112, the alignment pin 113, the rear insertion boundary 114, the threaded pin 115, supports 116 and 117 of the swing plates, the pin 118, the pressure strip 119, the supports 120 and 121, the motor carrier 122, the ball bearing 123, and the adapter plate 124.

The perspective illustration in FIG. 2 relates to essential components of the fixing device 15 from FIG. 1 and illustrates the spatial configuration of the drive motor 16 of the fixing device 15 in relation to the actuating strip 19 and the leaf-spring-like fixing elements 20 (for the sake of clarity, of all fixing elements 20 present in the actuating strip 19, only the three lower fixing elements 20 are expressly identified in FIG. 2) and/or the spring strip 21. The individual leaf-spring-like fixing elements 20 of the spring strip 21 are each provided for fixing one object (not shown in FIGS. 1 and 2) in one object storage point. The individual leaf springs or leaf-spring-like fixing elements 20 are connected to one another and form the spring strip 21 in their entirety as shown in FIG. 2. Specifically, the individual leaf-spring-like fixing elements 20 are situated like a comb in relation to one another in their entirety, one comb tine and/or one finger (=one leaf-spring-like fixing element 20) being provided for fixing one object in one object storage point.

As shown in FIG. 2, the drive motor 16 drives a rotational movement of the threaded spindle 22, over whose thread course (not shown) the dog nut 23 is guided, which is mounted so it is rotatable in a torque transfer element 26. The transfer element 26 has a connection area 27 to a pivot axis 28, which is connected to the actuating strip 19 (eccentric strip), diametrically opposite the forked area of the transfer element 26. The dog nut 23 having internal thread thus moves along the rotational axis of the threaded spindle 22 having external thread due to a rotational movement of the threaded spindle 22 around its longitudinal axis driven by the drive motor 16. The linear movement of the dog nut 23 in turn causes a pivot movement around the pivot axis of the actuating strip 19 via the transfer element 26. This pivot movement is indicated by the arrow C-C′ in FIG. 2. If the actuating strip 19 pivots toward the leaf-spring-like fixing elements 20 of the spring strip 21 (arrow direction C), the actuating strip 19 first is incident against a finger-like stop area 29 of the spring strip 21. If the actuating strip 19 is pivoted further in this direction, finally the leaf-spring-like fixing elements 20 are pivoted by the actuating strip 19. The actuating strip 19 thus exerts an actuating force on the leaf-spring-like fixing elements 20. The actuating strip 19 is mounted so it is pivotable in its base area (bottom in FIG. 2) in the storage cassette (not shown further in FIG. 2).

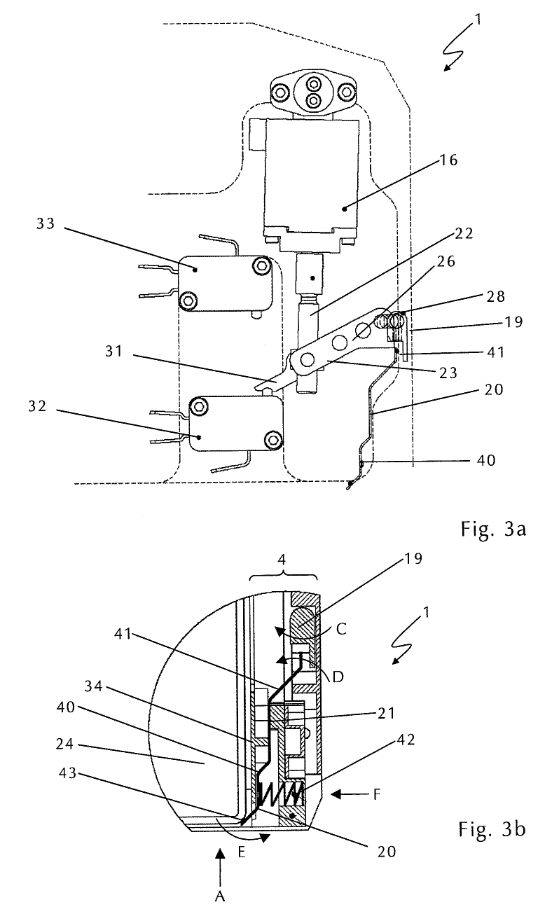

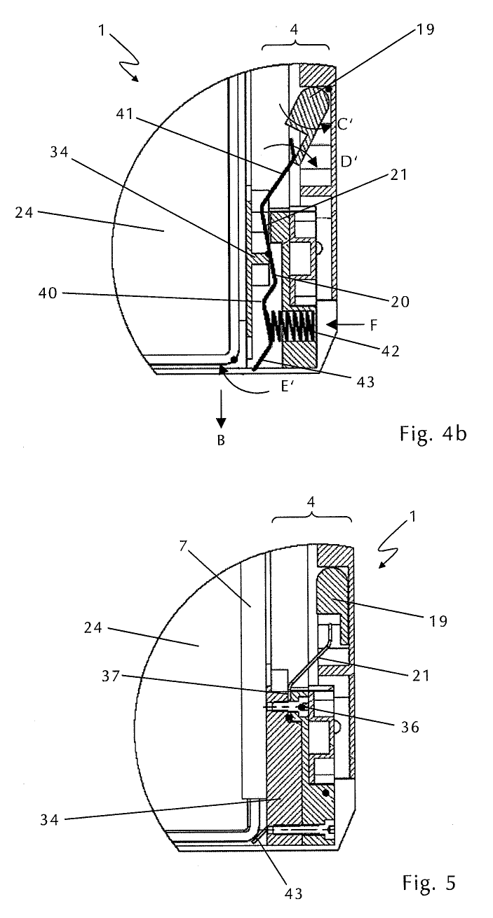

A further essential component of the fixing device 15 is the spring strip 21 implemented like a comb, already noted, which comprises one leaf-spring-like fixing element 20 per object storage point. This strip is attached as shown in FIG. 1 to a side wall of the storage cassette (to the ladder 6′ of the side wall 4 in FIG. 1) using the fastening screws 36 (only one of the fastening screws 36 is identified as an example in FIG. 5). Each fixing element comprises a control lever 41, which may be contacted by the actuating strip 19 in the stop area 29, and a fixing lever 40, which is implemented to fix an object stored in an object storage point (not shown in FIG. 2). This is also only identified in greater detail for one fixing element 20 as an example in FIG. 2. The fastening screws 36 are guided through the spring strip 21 in the area between the fixing lever 40 and the control lever 41 through a through opening 35 and thus fix the point of rotation of the leaf-spring-like fixing element 20. By its pivot movement, the actuating strip 19 may contact the spring strip 21, as a result, the settings of all leaf-spring-like fixing elements 20 of the storage cassette are jointly movable from a “fix” position, in which an object located in an object storage point is fixed in its position by the fixing element, into a “release” position, in which the fixing of the object located in the object storage point by the fixing element is canceled out. The detailed mode of operation of the fixing device 15 from FIG. 2 is illustrated in greater detail in FIGS. 3a through 5.

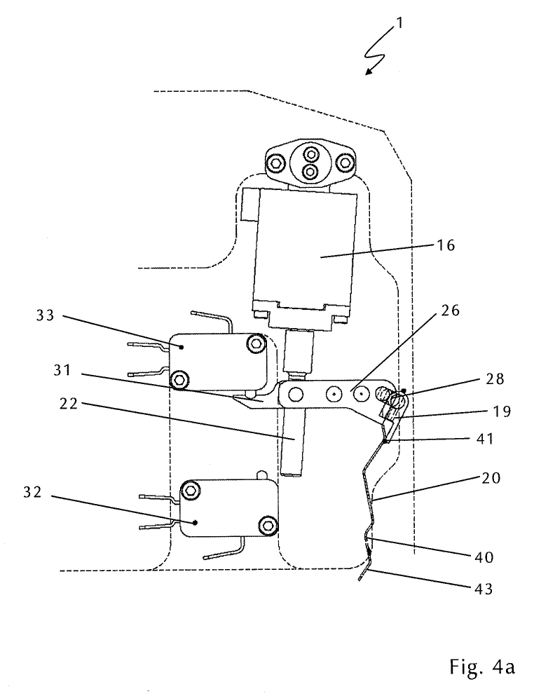

FIGS. 3a and 3b relate to the fixing device 15 in the “fix” position, in which an object 24 (only a partial area of the object 24 is shown in FIGS. [number missing] and 4b), in the present case a titration plate, is fixed in an object storage point. The insertion direction of the object 24 into the object storage point of the object storage device 1 is indicated by the arrow A. The “release” position is shown in FIGS. 4a and 4b, in which the object 24 (also only partially illustrated in FIG. 4b) may be pulled out of the object storage point in the direction of the arrow B. In FIGS. 3a and 4a, some wall shapes of the object storage device are also indicated by dashed lines. In regard to the fixing device 15 from FIG. 2, which is installed in an object storage device 1, FIGS. 3b and 4b represent a horizontal section through the fixing device along line I-I from FIG. 2 and FIG. 5 represents a horizontal section along line II-II from FIG. 2.

FIGS. 3a and 4a represent a top view from above of a partial area of the storage cassette 2 of the object storage device 1 having the fixing device 15 from FIG. 2. According to FIGS. 3a and 4a, the transfer element 26, which mounts the dog nut 23, which the threaded spindle 22 passes through, so it is pivotable in the movement plane of the storage cassette 2 and is connected via the pivot axis 28 to the actuating strip 19, has a contact finger 31 for switch actuation of the switches 32 and 33, which are situated diametrically opposite. The operating interval of the drive motor 16 is controlled via the switches 32 and 33, so that the dimensions of the pivot movement of the actuating strip 19 as shown by the arrow directions C and/or C′ (from FIGS. 2, 3b, and 4b) are a function of the contacting of the particular switches 32 and 33. The pivot movement of the actuating strip 19 driven by the drive motor 16 thus runs in the direction C up to the actuation of the switch 33 by the contact finger 31 and in the direction C′ up to the actuation of the switch 32.

In the “fix” position shown in FIGS. 3a and 3b, the leaf-spring-like fixing element 20 acts orthogonally and/or laterally against the object 24 introduced into the object storage point in relation to the insertion direction A and presses it against the side wall area (not shown) of the object storage point opposite to the fixing element 20. This action of the fixing element 20 is caused by a compression spring 42, which is situated on the side of the fixing element 20 facing away from the object between a wall area of the side wall 4 and the fixing element 20. The compression spring 42 acts on the fixing element 20 in the direction of the arrow F (FIGS. 3b and 4b). It is also possible in the scope of the present invention not to provide an individual compression spring 42 for each object storage point. However, in the embodiment shown in FIGS. 1 through 5, one compression spring 42 is situated in the object storage device for each object storage point and/or for each fixing element 20 (however, in the sectional view from FIGS. 3b and 4b, only one compression spring 42 is shown in each case). On the side of the spring strip 21 diametrically opposite to the compression spring stop area, in which the spring strip 21 is implemented in a partial area parallel to the side wall 4 of the object storage point, on the fixing element 20, an intermediate wall 34 is provided, which spatially separates this area of the spring strip 21 and the inner chamber of the storage cassette 2 housing the object 24. In the “fix” position, the fixing element 20 of the spring strip 21 stops against this intermediate wall 34 at this partial area, by which the dimensions of the movement of the fixing element 20 in the fixing direction E′ (FIG. 4b) are delimited. The fixing element 20 also has a wraparound 43 toward the insertion opening of the object storage point (on the bottom in the sectional illustration from FIG. 3b), which encloses the front edge of the object 24 (thus the titration plate in the present case) facing toward the object storage point exit and, through this wraparound, in addition to the fixing in the object storage point, simultaneously presses it into the object storage point in the insertion direction A. In the tip area and/or in the area of the wraparound 43, the fixing element 20 thus projects into the inner chamber of the object storage point in the “fix” position. The fixing element 20 and/or the spring strip 21 is also guided through the side wall 4 of the storage cassette in such a way that it projects with a contact area into the pivot chamber of the actuating strip 19 at the part of the fixing element 20 facing away from the wraparound 43.

The spring strip 21 is mounted on the intermediate wall 34 so it is pivotable in the horizontal plane. Such a mounting may be obtained using screws or bolts, which connect the leaf springs to the intermediate wall as part of the side wall, because of the spring properties of the spring strip. In the present exemplary embodiment, the spring strip 21 has a fastening area 37 for this purpose, in which a fastening screw 36 is guided between each two object storage points through a through opening 35 of the spring strip 21. Such a connection point is particularly visible from the sectional view of FIG. 5 along line II-II in FIG. 2. According to FIG. 5, the spring strip 21 is accordingly fastened using the fastening screw 36 to a component, according to FIG. 5 to the intermediate wall 34, of the side wall (in FIG. 5 on the side wall 4) for fastening. In the fastening areas of the spring strip 19, the spring strip 19 thus does not have, in contrast to the areas having the fixing element 20 at the height of the object storage points, a leaf-spring-like fixing element 20, which is implemented to fix the object in an object storage point, but rather essentially only the fastening area 37.

To release the object 24, the actuating strip 19 is pivoted, driven by a motor, around its pivot axis in the arrow direction C. Due to this pivot movement, a stop area of the actuating strip 19 is incident on the stop area 29 of the spring strip 21 and presses the stop area 29 in the arrow direction D. The spring strip 21 is thus pivoted around its point of rotation, which is established by the fastening screw 36 in the fastening area 37, into the “release” position of the fixing element 20. Each of the fixing elements 20 is thus a two-arm lever having the fixing lever 40, which contacts the object 24 to fix it and fixes it in the object storage point, and the control lever 41, at which the actuating strip 19 impinges against the spring strip 21. The fixing element 20 is thus pivoted around its point of rotation and opposite to the compression spring 42 acting on the fixing lever 40 in the “fix” position by the pivot movement of the actuating strip 19.

The movement sequences of the fixing lever 40, the control lever 41, the actuating strip 19, and the compression spring 42 in relation to one another are illustrated in greater detail in FIGS. 3b and 4b by the arrows C-F. The arrows C-E relate to the movement directions of the actuating strip 19 (arrow C), the control lever 41 (arrow D), and the fixing lever 40 (arrow E) from the “fix” position in FIG. 3b into the “release” position in FIG. 4b. Accordingly, the arrows C′, D′, and E′ relate to the movement directions of the relevant elements from the “release” position into the “fix” position. Arrow F indicates the direction of the spring force exerted by the compression spring 42 on the fixing lever 40 of the fixing element 20 in FIGS. 3b and 4b. An essential feature of the configuration is thus that the actuating strip 19 finally pivots the fixing lever 40 in the direction E opposite to the spring tension of the compression spring 42 due to a pivot movement in the direction C and thus switches the fixing device 15 into the “release” position. Furthermore, the compression spring 42 presses on the fixing lever 40 in the direction F and thus moves the fixing lever 40 in the direction C′ back into the “fix” position as soon as the actuating strip 19 is pivoted in the direction of the starting position shown by arrow C′ from FIG. 3b. The actuating strip 19 thus indirectly controls the movement of the fixing lever 40 into the “fix” position.

What is claimed is:

1. An object storage device having shaking function having a vertically situated storage cassette, which has multiple object storage points situated one on top of another, and having a drive unit functionally connected to the storage cassette via a first drive connection, comprising a drive element for performing a shaking movement of the storage cassette,
wherein the drive unit is also functionally connected to the storage cassette via a second drive connection, the first drive connection being connected to a floor area and the second drive connection being connected to a head area of the storage cassette, and a control unit is provided, which is implemented to synchronize the two drive connections.

2. The object storage device wherein according to claim 1, wherein the first and second drive connections are opposite one another and the first drive connection is functionally connected from below and the second drive connection is functionally connected from above to the storage cassette.

3. The object storage device wherein according to claim 1, wherein the drive element is an electromagnetic drive.

4. The object storage device wherein according to claim 1, wherein the drive unit is implemented to perform various shaking movements and in particular to perform orbital, linear, and diagonal shaking movements.

5. The object storage device according to claim 1, wherein the drive unit has a first drive element and a second drive element, the first drive element being connected to the storage cassette via the first drive connection and the second drive element being connected via the second drive connection, and the control unit being implemented to synchronize the shaking movement performed by the first drive element and the second drive element.

6. The object storage device wherein according to claim 5, wherein the first drive element and the second drive element have identical constructions.

7. The object storage device wherein according to claim 5, wherein the drive unit and in particular the first drive element and the second drive element of the drive unit are implemented as moisture-tight.

8. The object storage device wherein according to claim 5, wherein the object storage device wherein has at least two storage cassettes, each of the storage cassettes having a first drive connection and a second drive connection.

9. The object storage device according to claim 8, wherein the control unit is implemented for separate control of the at least two storage cassettes.

10. The object storage device according to claim 8, wherein a fixing device is provided having a fixing element for fixing an object and in particular a plate-shaped sample carrier in one of the object storage points and having an actuating device, the actuating device being implemented to adjust the fixing element between a “fix” position and a “release” position, and the object being fixed in one of the object storage points in the “fix” position and being removable from this object storage point in the “release” position.

11. The object storage device according to claim 10, wherein fixing elements in multiple object storage points and in particular in all object storage points of the storage cassette are adjustable in a combined way between the “fix” position and the “release” position via the actuating device.

12. The object storage device according to claim 11, wherein the actuating device has a vertically situated actuating strip for the combined switching of all fixing elements of the storage cassette between the “fix” position and the “release” position.

13. The object storage device according to claims 10, wherein the fixing element comprises a two-arm lever having a control lever and a fixing lever, the control lever for switching the fixing element from the “fix” position into the “release” position being implemented as in contact with the actuating device and in particular with the actuating strip, and the fixing lever being implemented in such a way that it presses with at least a partial area laterally against the object to fix the object in the object storage point.

14. The object storage device according to claim 13, wherein the two-arm lever is a leaf spring.

15. The object storage device according to claim 13, wherein, in the “fix” position, the fixing lever encloses the object introduced into the object storage point in the area of the object front edge to prevent the object from slipping out of the object storage point.

16. The object storage device according to claim 13, wherein the fixing lever is spring-loaded in such a way that the spring loading acts in the “fix” position of the fixing lever.

17. The object storage device according to claim 10, wherein the fixing device is motor-driven.

18. The object storage device according to claim 10, wherein the fixing device has a self-locking gear.

19. The object storage device according to claim 10, wherein the fixing device has a locking device for locking the storage cassette in a defined loading and unloading position, the locking device being implemented in such a way that it locks the storage cassette as long as the fixing element is located in the “release” position.

20. A climatic cabinet, especially an incubator and particularly an automated incubator, having an object storage device having shaking function, wherein the object storage device is implemented according to claim 1.
